(19) United States
(12) Patent Application Publication
(10) Pub. No.: US 2025/0386345 A1
(43) Pub. Date: Dec. 18, 2025

(54) MULTIPLEXING UPLINK CONTROL INFORMATION ON NON-OVERLAPPING TRANSMISSIONS

(71) Applicant: QUALCOMM Incorporated, San Diego, CA (US)

(72) Inventors: Gabi SARKIS, San Diego, CA (US); Jing JIANG, San Diego, CA (US); Mostafa KHOSHNEVISAN, San Diego, CA (US); Weimin DUAN, San Diego, CA (US); Kangqi LIU, San Diego, CA (US); Diana MAAMARI, San Diego, CA (US); Le LIU, San Jose, CA (US); Yi HUANG, San Diego, CA (US)

(21) Appl. No.: 18/742,573

(22) Filed: Jun. 13, 2024

(51) Int. Cl. H04W 72/21; H04W 72/0446; H04W 72/563

(52) U.S. Cl. CPC H04W 72/21; H04W 72/0446; H04W 72/563

(57) ABSTRACT

Methods, systems, and devices for wireless communications are described. A user equipment (UE) may identify uplink control information (UCI) for transmission via a first potential uplink control channel transmission and identify a second uplink transmission that is non-overlapping in time with the first potential uplink control channel transmission. The second uplink transmission may include an uplink shared channel transmission or a second uplink control channel transmission. The UE may transmit the UCI as part of the second uplink transmission based on a determination that the second uplink transmission satisfies one or more conditions.

### FIELD OF TECHNOLOGY

The following relates to wireless communications, including multiplexing uplink control information on non-overlapping transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Wireless communications between devices, such as a UE and a network entity, may include uplink and downlink communications.

### SUMMARY

The systems, methods, and devices of this disclosure each have several innovative aspects, no single one of which is solely responsible for the desirable attributes disclosed herein.

A method for wireless communications by a user equipment (UE) is described. The method may include identifying uplink control information (UCI) for transmission via a first potential uplink control channel transmission, identifying a second uplink transmission that is non-overlapping in time with the first potential uplink control channel transmission, the second uplink transmission being an uplink shared channel transmission or a second uplink control channel transmission, and transmitting the UCI as part of the second uplink transmission based on a determination that the second uplink transmission satisfies one or more conditions.

A UE for wireless communications is described. The UE may include one or more memories storing processor executable code, a transceiver, and one or more processors coupled with the one or more memories and the transceiver. The one or more processors may individually or collectively be operable to execute the code to cause the UE to identify UCI for transmission via a first potential uplink control channel transmission, identify a second uplink transmission that is non-overlapping in time with the first potential uplink control channel transmission, the second uplink transmission being an uplink shared channel transmission or a second uplink control channel transmission, and transmit, via the transceiver, the UCI as part of the second uplink transmission based on a determination that the second uplink transmission satisfies one or more conditions.

Another UE for wireless communications is described. The UE may include means for identifying UCI for transmission via a first potential uplink control channel transmission, means for identifying a second uplink transmission that is non-overlapping in time with the first potential uplink control channel transmission, the second uplink transmission being an uplink shared channel transmission or a second uplink control channel transmission, and means for transmitting the UCI as part of the second uplink transmission based on a determination that the second uplink transmission satisfies one or more conditions.

A non-transitory computer-readable medium storing code for wireless communications is described. The code may include instructions executable by one or more processors to identify UCI for transmission via a first potential uplink control channel transmission, identify a second uplink transmission that is non-overlapping in time with the first potential uplink control channel transmission, the second uplink transmission being an uplink shared channel transmission or a second uplink control channel transmission, and transmit, via the transceiver, the UCI as part of the second uplink transmission based on a determination that the second uplink transmission satisfies one or more conditions.

In some examples of the method, UEs, and non-transitory computer-readable medium described herein, the one or more conditions include receipt by the UE of signaling indicative that transmission of the UCI as part of the second uplink transmission is allowed.

In some examples of the method, UEs, and non-transitory computer-readable medium described herein, the one or more conditions include a time gap between the first potential uplink control channel transmission and the second uplink transmission satisfying a time gap threshold.

Some examples of the method, UEs, and non-transitory computer-readable medium described herein may further include operations, features, means, or instructions for receiving, via the transceiver, an indication of a duration of the time gap threshold.

In some examples of the method, UEs, and non-transitory computer-readable medium described herein, a duration of the time gap threshold is based on a priority of the first potential uplink control channel transmission, a priority of the second uplink transmission, or both.

In some examples of the method, UEs, and non-transitory computer-readable medium described herein, the one or more conditions are based on a priority of the first potential uplink control channel transmission, a priority of the second uplink transmission, or both.

In some examples of the method, UEs, and non-transitory computer-readable medium described herein, the one or more conditions are based on a size of the UCI, a type of the UCI, or both.

In some examples of the method, UEs, and non-transitory computer-readable medium described herein, the one or more conditions are based on a size of a codebook associated with the UCI, a type of the codebook associated with the UCI, or both.

In some examples of the method, UEs, and non-transitory computer-readable medium described herein, the one or more conditions are based on a size of the first potential uplink control channel transmission, a size of the second uplink transmission, or both.

In some examples of the method, UEs, and non-transitory computer-readable medium described herein, the one or more conditions include a second start time for the second uplink transmission being after a first start time for the first potential uplink control channel transmission and further include no other uplink transmission for the UE having a start time that is between the first start time for the first potential uplink control channel transmission and the second start time for the second uplink transmission.

In some examples of the method, UEs, and non-transitory computer-readable medium described herein, when a second start time for the second uplink transmission is earlier than a first start time for the first potential uplink control channel transmission, the one or more conditions include the second start time satisfying one or more processing time thresholds associated with the UCI, the second uplink transmission, or any combination thereof.

In some examples of the method, UEs, and non-transitory computer-readable medium described herein, the one or more conditions include a second start time for the second uplink transmission being nearer in time to a first start time for the first potential uplink control channel transmission than any other uplink transmission for the UE for which one or more processing time thresholds associated with the UCI, the second uplink transmission, or any combination thereof are satisfied.

In some examples of the method, UEs, and non-transitory computer-readable medium described herein, the one or more conditions include the second uplink transmission having a second end time that is earlier than a first end time for the first potential uplink control channel transmission and further include an absence of any other uplink transmission having a start time that is within a threshold duration of the first potential uplink control channel transmission.

In some examples of the method, UEs, and non-transitory computer-readable medium described herein, the one or more conditions include the second uplink transmission having a priority that is lower than one or more other uplink transmissions for the UE, the second uplink transmission having a greater resource allocation than the one or more other uplink transmissions for the UE, the second uplink transmission having a lower modulation and coding scheme than the one or more other uplink transmissions for the UE, or any combination thereof.

In some examples of the method, UEs, and non-transitory computer-readable medium described herein, a plurality of uplink transmissions for the UE includes the first potential uplink control channel transmission and the second uplink transmission, the plurality of uplink transmissions associated with two or more carriers, and the one or more conditions include the second uplink transmission satisfying a selection criteria associated with the two or more carriers.

In some examples of the method, UEs, and non-transitory computer-readable medium described herein, transmitting the UCI as part of the second uplink transmission is further based on the first potential uplink control channel transmission being dropped.

Some examples of the method, user equipment (UEs), and non-transitory computer-readable medium described herein may further include operations, features, means, or instructions for transmitting capability information for the UE that indicates: a capability of the UE to transmit UCI associated with an uplink control channel transmission via a different uplink transmission that is non-overlapping in time with the uplink control channel transmission, a minimum time gap between the uplink control channel transmission and the different uplink transmission for which the UE supports transmitting UCI associated with the uplink control channel transmission via the different uplink transmission, a maximum time gap between the uplink control channel transmission and the different uplink transmission for which the UE supports transmitting UCI associated with the uplink control channel transmission via the different uplink transmission, or any combination thereof.

In some examples of the method, UEs, and non-transitory computer-readable medium described herein, transmitting the UCI as part of the second uplink transmission is in accordance with a maximum quantity of UCI messages for transmission via the second uplink transmission, a maximum amount of UCI for transmission via the second uplink transmission, or both.

In some examples of the method, UEs, and non-transitory computer-readable medium described herein, transmitting the UCI as part of the second uplink transmission includes: transmitting, within the second uplink transmission, a medium access control-control element that includes the UCI.

In some examples of the method, UEs, and non-transitory computer-readable medium described herein, based on transmitting the UCI as part of the second uplink transmission, the first potential uplink control channel transmission is not transmitted.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports multiplexing UCI (uplink control information) on non-overlapping transmissions in accordance with one or more aspects of the present disclosure.

FIG. 2 shows an example of a wireless communications system that supports multiplexing UCI on non-overlapping transmissions in accordance with one or more aspects of the present disclosure.

FIGS. 3A and 3B show examples of signaling diagrams that support multiplexing UCI on non-overlapping transmissions in accordance with one or more aspects of the present disclosure.

FIG. 4 shows an example of a signaling diagram that supports multiplexing UCI on non-overlapping transmissions in accordance with one or more aspects of the present disclosure.

FIG. 5 shows an example of a process flow diagram that supports multiplexing UCI on non-overlapping transmissions in accordance with one or more aspects of the present disclosure.

FIGS. 6 and 7 show block diagrams of devices that support multiplexing UCI on non-overlapping transmissions in accordance with one or more aspects of the present disclosure.

FIG. 8 shows a block diagram of a communications manager that supports multiplexing UCI on non-overlapping transmissions in accordance with one or more aspects of the present disclosure.

FIG. 9 shows a diagram of a system including a device that supports multiplexing UCI on non-overlapping transmissions in accordance with one or more aspects of the present disclosure.

FIGS. 10 and 11 show flowcharts illustrating methods that support multiplexing UCI on non-overlapping transmissions in accordance with one or more aspects of the present disclosure.

### DETAILED DESCRIPTION

Wireless communications between devices, such as a user equipment (UE) and a network entity, may include uplink and downlink communications. For example, a UE may transmit messages via a physical uplink control channel (PUSCH), a physical uplink shared channel (PUSCH), or both. In some examples, potential messages (e.g., messages that may be transmitted at some future time, such as messages that are scheduled to occur or planned for transmission on some other basis) may overlap in time, and information form one of the messages may be multiplexed into the other—e.g., information that would have been transmitted via a first message but for the multiplexing may instead be transmitted via a second message, with the first message potentially dropped (e.g., not transmitted), where the first and second messages would have overlapped at least partially in time had they both been transmitted. For example, uplink control information (UCI) identified for transmission via a PUCCH message may be multiplexed into a PUSCH message if the PUCCH message and the PUSCH message would overlap in time were they both transmitted. Such multiplexing of information that would have otherwise been transmitted via a first message into a second message may alternatively be referred to in some cases as multiplexing the first message or as multiplexing the first and second messages.

Limiting multiplexing to temporally overlapping messages may limit opportunities for a wireless device (e.g., a UE) to remain in a low power (e.g., sleep) state—e.g., the wireless device may exit the low power state undesirably soon in order to transmit a message, or the wireless device may be unable to enter a lower power state due to an insufficiently long gap between messages, among other potential scenarios. Thus, enabling a wireless device to multiplex non-overlapping messages may provide power savings, by allowing the wireless device to enter a lower power state more often, for longer durations at a time, or both, among other potential benefits. However, enabling a wireless device to multiplex non-overlapping messages without any related constraints may undesirably increase unpredictability and hence complexity of operation within a wireless communications network, among other potential drawbacks.

Aspects of the disclosure herein provide for multiplexing non-overlapping messages when one or more associated conditions (e.g., criteria, rules) are satisfied, which may allow for increased energy savings by wireless devices while avoiding undesirable unpredictability or complexity within a wireless communications network, among other potential benefits. For example, multiplexing of messages may be performed (e.g., allowed) when one or more conditions related to the relative timing of the messages are satisfied (e.g., when a time gap between respective start times for the messages satisfies a threshold) or may be performed (e.g., allowed) when one or more conditions related to priorities of, sizes of, content type of, codebook size for, or codebook type for the messages are satisfied, among other examples. Selection criteria for selecting a destination message into which information associated with a source message is to be transmitted are also described, along with other techniques and features related to multiplexing non-overlapping messages.

Aspects of the disclosure are initially described in the context of wireless communications systems. Aspects of the disclosure are further illustrated by and described with reference to signaling diagrams and a process flow diagram. Aspects of the disclosure are further illustrated by and described with reference to apparatus diagrams, system diagrams, and flowcharts that relate to multiplexing UCI on non-overlapping transmissions.

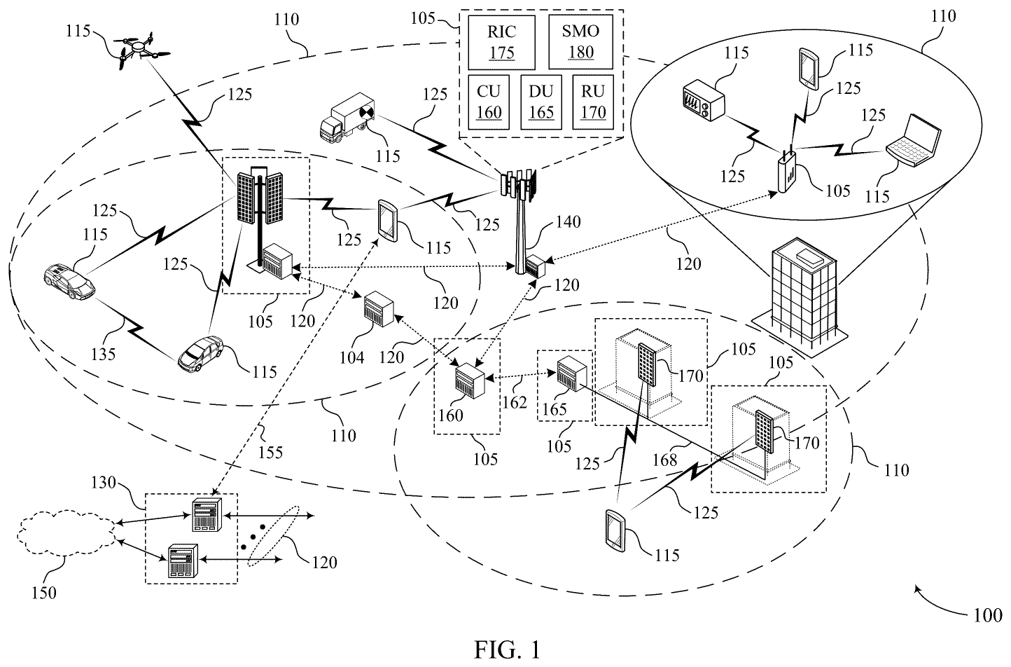

FIG. 1 shows an example of a wireless communications system 100 that supports multiplexing UCI on non-overlapping transmissions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UE 115-a may communicate various uplink message via uplink channels, such as a PUCCH or a PUSCH. UCI may be included as part of a PUCCH transmission. In some examples, if a scheduled PUSCH transmission and a scheduled PUCCH transmission overlap in time, the UE 115-a may include the UCI of the PUCCH as part of the PUSCH, and not transmit the PUCCH. That is, the UE 115-a may multiplex the UCI on the PUSCH when the PUSCH and the PUCCH overlap in time.

However, in some examples, PUCCH and PUSCH transmissions may not overlap in time, but may be sufficiently close as to disrupt a power efficient state of the UE 115-a. If the time between the transmissions (e.g., PUCCH and PUSCH, two PUCCH transmissions, or two PUSCH transmission) is too short, the UE 115-a may be unable to enter a power efficient state, or may expend energy entering and exiting a power efficient state. Removing one of the transmissions may lengthen the time between transmissions, resulting in a more efficient sleep state.

Techniques described herein provide for multiplexing non-overlapping messages when one or more conditions are satisfied, which may result in more frequent low power states, longer low power durations, or both among other advantages. For example, UCI that would otherwise be transmitted via a first PUCCH message may instead be transmitted via a PUSCH message or via a second PUCCH message, based on the first PUCCH message and the destination message (the PUSCH message or the second PUCCH message) satisfying one or more conditions.

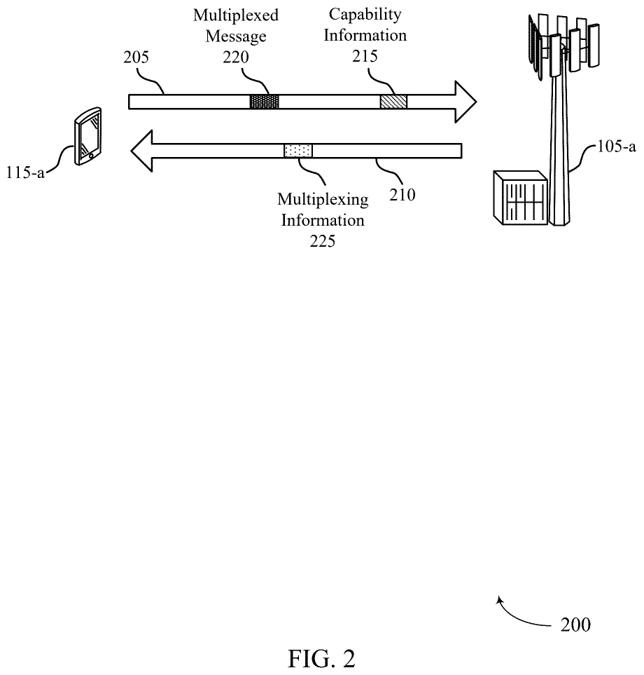

FIG. 2 shows an example of a wireless communications system 200 that supports multiplexing UCI on non-overlapping transmissions in accordance with one or more aspects of the present disclosure. The wireless communications system 200 describes the communications between a UE 115-a and a network entity 105-a. The UE 115-a and the network entity 105-a may be examples of the UE 115 and the network entity 105 as described with reference to FIG. 1. The network entity 105-a and the UE 115-a may communicate via a communication link 205 (e.g., an uplink) and a communication link 210 (e.g., a downlink).

In some examples, the UE 115-a may transmit capability information 215, which may indicate one or more capabilities of the UE 115-a associated with multiplexing UCI on non-overlapping transmissions. For example, the UE 115-a may indicate that it is capable of multiplexing the UCI that would other be transmitted via a first PUCCH transmission into a second transmission (e.g., a PUSCH transmission or a second PUCCH transmission) when the first PUCCH and the second transmission would not overlap in time. The UE 115-a may also report the minimum gap, maximum gap, or both, between the first PUCCH transmission and the second transmission for which the UE 115-a is able to multiplex the UCI on the second transmission. Though a single capability information 215 message is illustrated in FIG. 2, it is to be understood that alternatively capability information 215 may be communicated via any quantity of messages.

Additionally or alternatively, in some examples, the network entity 105-a may transmit to the UE 115-a multiplexing information 225. For example, the network entity 105-a may transmit multiplexing information 225 after (e.g., in response to) receipt of the capability information 215 from the UE 115-a. Alternatively, the network entity 105-a may transmit multiplexing information 225 at some other time, such as prior to receipt of the capability information 215 from the UE 115-a, or in some cases (such as examples in which the UE 115-a does not transmit capability information 215) without regard to the receipt of any capability information 215 or the timing thereof. Though a single multiplexing information 225 message is illustrated in FIG. 2, it is to be understood that alternatively multiplexing information 225 may be communicated via any quantity of messages. The multiplexing information 225 may indicate one or more conditions for multiplexing non-overlapping transmissions as described herein, parameters associated with such conditions, or any combination thereof. The multiplexing information 225 may be transmitted via one or more RRC message, via one or more MAC-CEs, or any combination thereof.

The UE 115-a may transmit a multiplexed message 220 to the network entity 105-a. The multiplexed message 220 may, for example, be a PUSCH message or a PUCCH message that includes UCI that, but for having been multiplex into the multiplex message 220, would otherwise have been transmitted via a different message (e.g., via a PUCCH message), which may be referred to as the source message or alternatively as the source transmission. In some cases, the UE 115-a may drop (e.g., not transmit, refrain from transmitting) the source message, and hence the source message is not illustrated in the example of FIG. 2. The multiplexed message 220 thus may be the message into which the UCI is multiplexed and may alternatively be referred to as a target message (or target transmission) or destination message (or destination transmission).

In some examples, the UCI may be multiplexed into the multiplexed message 220 as a MAC-CE (e.g., to multiplex the UCI into the multiplexed message 220, the UE 115-a may generate a MAC-CE that includes the UCI and incorporate the UCI into the multiplexed message 220). For example, if the UCI only contains channel state information (CSI), the UCI may be multiplexed as a MAC-CE. Alternatively, in some examples, UCI may be directly multiplexed into the multiplexed message 220, such as by being separately encoded (e.g., using polar codes) and mapped to one or more of the REs via which the multiplexed message 220 is transmitted.

The UE 115-a may multiplex the UCI associated with the source message into the multiplexed message 220 despite the source message not overlapping (e.g., not being scheduled or otherwise slated to overlap) with the multiplexed message 220 based on one or more conditions being satisfied as described herein. For example, multiplexing may not be allowed if the time gap between the source message and the destination message exceeds a threshold. That is, if the source message and the destination message are slated to occur too far apart in time, the UE 115-a may not perform multiplexing. The threshold may be configured or indicated via radio resource control (RRC) signaling, or as part of a medium access control (MAC) control element (MAC-CE) (e.g., as part of multiplexing information 225). In some examples, the threshold may be a function of a field associated with the source message or the destination message, such as a timing indicator (e.g., PDSCH-to-HARQ_feedback timing indicator). For example, multiplexing may be allowed if the gap is 1.5*the timing indicator.

In some examples, the network (e.g., the network entity 105-a) may indicate whether multiplexing UCI from a source message into a non-overlapping destination message is or is not allowed (e.g., as part of multiplexing information 225)—e.g., whether multiplexing a UCI from a source message into a non-overlapping destination message is currently allowed or is allowed for some associated time period or set of transmission resources. The indication may be indicated via RRC signaling, a MAC-CE, or as part of a resource grant. The resource grant may trigger the UCI transmissions, such as a resource grant for downlink data that triggers feedback by the UE 115-a, or such as a resource grant that triggers a channel state information (CSI) report trigger by the UE 115-a. In some examples, the destination message may be a PUSCH message, and the resource grant that triggers the PUSCH transmission may indicate whether multiplexing of UCI from a non-overlapping source message into the PUSCH message is allowed.

In some examples, multiplexing may be dependent on the priority of the PUCCH, the PUSCH, or both. For example, if the source message is a PUCCH message with a higher priority and comes before the destination message, the UCI may be transmitted as part of the PUCCH message (e.g., without multiplexing) to avoid any delay in transmission of the UCI. Additionally or alternatively, as another example, UCI associated with a lower-priority source message may not be allowed to be multiplexed into a higher-priority destination message (e.g., to avoid degrading a quality or reliability of the destination message), and hence a condition for multiplexing may be that a priority of the source message be equal to or higher than a priority of the destination message.

Additionally or alternatively, multiplexing may or may not be allowed based on factors such as the content of the UCI, the size of the UCI, or both. For example, if the UCI indicates scheduling resources, the UCI may not be multiplexed and may be transmitted separately, while multiplexing may be allowed for other types of UCI. Additionally or alternatively, multiplexing may be allowed when a size of the UCI is less than or equal to a threshold size and may not be allowed when the size of the UCI is greater than the threshold size.

Multiplexing may or may not be allowed based on the type, size, or both of a HARQ-ACK codebook associated with the UCI. For example, multiplexing may be allowed when a size of the HARQ-ACK codebook is less than or equal to a threshold size and may not be allowed when the size of the HARQ-ACK codebook is greater than the threshold size. Additionally or alternatively, as another example, multiplexing may be allowed when the HARQ-ACK codebook is of one or more particular types (e.g., when the codebook HARQ-ACK codebook is a Type 3 codebook, which may be a “one-shot” type that allows the network entity 105-a to request feedback of a HARQ-ACK codebook for all configured downlink HARQ processes for all configured component carriers for the UE 115-a) and may not be allowed when the HARQ-ACK codebook is of one or more other particular types. In some examples, multiplexing may not be allowed based on the amount (e.g., size) of content of the destination message. For example, the content of the destination message may be too large for multiplexing additional information (e.g., UCI) into the destination message.

The source message may be slated (e.g., scheduled or otherwise set to occur) to be earlier in time or later in time that the destination message. In some examples, the UE 115-a may multiplex on the earliest other transmission, whether a PUSCH or PUCCH, that starts after the source PUCCH associated with the UCI would occur, subject to one or more other conditions (e.g., a time gap threshold) being satisfied. In some examples, if there are potential destination messages both before and after source PUCCH associated with the UCI would occur, the UE 115-a may multiplex the UCI into the potential destination messages that occurs after the source PUCCH associated with the UCI would have occurred.

In some examples, if there are potential destination messages both before and after source PUCCH associated with the UCI would occur, the UE 115-a may multiplex the UCI into the potential destination messages that occurs before the source PUCCH associated with the UCI would have occurred so long as one or more processing time constraints are satisfied (e.g., minimum time gaps associated with transmitting the UCI, such as when the UCI is HARQ-ACK information that the UE 115-a may not be expected to transmit any earlier than some minimum time gap relative to a corresponding downlink message or any later than some maximum time gap relative to the corresponding downlink message), and the UE 115-a may multiplex the UCI into the potential destination messages that occurs after the source PUCCH associated with the UCI would have occurred if the one or more processing time constraints are not satisfied.

And in some examples, if there are potential destination messages both before and after source PUCCH associated with the UCI would occur, the UE 115-a may multiplex the UCI into whichever potential destination message is nearest in time (e.g., with respect to start time) to the source PUCCH associated with the UCI and for which the one or more processing time constraints are satisfied.

Or, in some examples, if there are potential destination messages both before and after source PUCCH associated with the UCI would occur, the UE 115-a may multiplex the UCI into a destination message that is after the source PUCCH if that later destination message would start sufficiently soon as to satisfy the one or more processing time constraints, but if not, then the UE 115-a may multiplex the UCI into the latest-occurring destination message having an end time that is earlier than the end time of the source PUCCH.

In some examples, when there are multiple potential destination messages for which one or more multiplexing conditions are satisfied, the UE 115-a may select which transmission to multiplex the UCI into based on one or more criteria (which may be considered additional conditions). For example, the UE 115-a may multiplex the UCI into the destination transmission with lowest priority amount the multiple potential destination messages. Additionally or alternatively, the UE 115-a may multiplex the UCI into the destination message, from among the multiple potential destination messages, with the greatest amount of allocated resources, with the most robust (e.g., lowest) Modulation and Coding Scheme (MCS), or any combination thereof.

In some wireless communications systems, transmissions may be dropped by the UE 115-a for one or more reasons, such as due to prioritization between uplink signals or overlap with downlink signals (e.g., such as if the UE 115-a is not capable of full-duplex operation in full-division duplex scenarios). In some examples, multiplexing by the UE 115-a of UCI associated with a source PUCCH message into a non-overlapping destination message may be allowed if the source PUCCH message is to be dropped (e.g., multiplexing may be limited only to overlapping destination messages or may not be allowed at all unless the source PUCCH message is to be dropped).

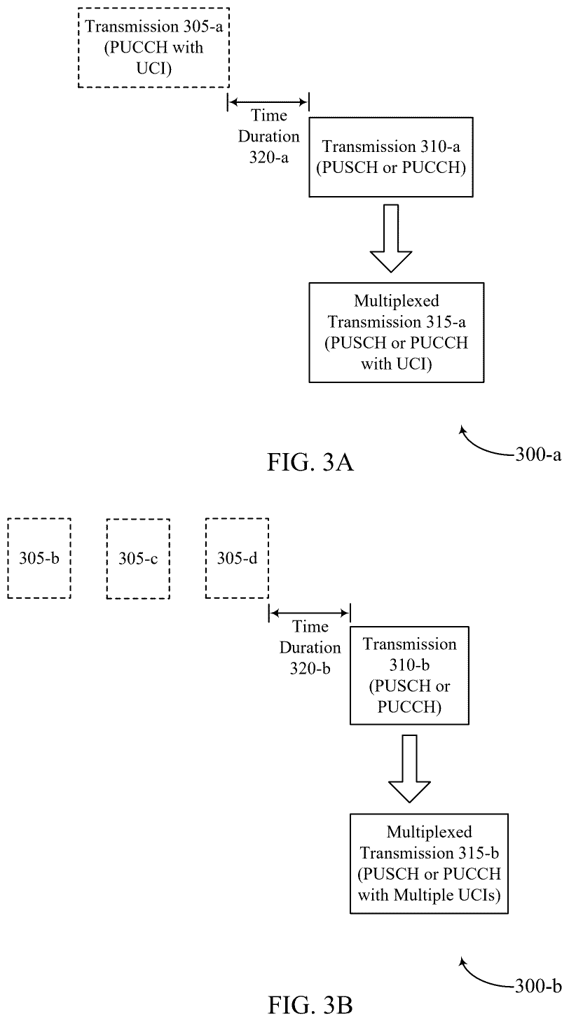

FIGS. 3A and 3B show examples of signaling diagrams 300 that support multiplexing UCI on non-overlapping transmissions in accordance with one or more aspects of the present disclosure. The signaling diagrams 300 illustrate the multiplexing of one or more UCIs associated with one or more source transmissions 305 into a destination transmission 310. The signaling diagram 300 may be implemented by a wireless communications system as described herein. In some examples, the multiplexing may be performed by a UE, such as a UE 115 as described herein.

In some examples, such as the example illustrated in the signaling diagram 300-a of FIG. 3A, a single source transmission 305-a may be associated with UCI (e.g., were it not multiplexed into destination transmission 310-a, the UCI would be transmitted via the source transmission 305-a). The source transmission 305-a may be a PUCCH transmission. The source transmission 305-a may be non-overlapping with the destination transmission 310-a and hence may be separated from the destination transmission 310-a by a time duration 320. The time duration 320 may be less than a threshold defined for multiplexing. The destination transmission 310-a may be a PUSCH or a PUCCH. The UCI may be multiplexed into (e.g., included in, incorporated into) the destination transmission 310-a, and a resulting multiplexed transmission 315-a may be transmitted. If the destination transmission 310-a is a PUSCH transmission, the multiplexed transmission 315-a may be a PUSCH transmission that includes the UCI along with any other contents that would have been included in the PUSCH transmission 310-a. If the destination transmission 310-a is a PUCCH transmission, the multiplexed transmission 315-a may be a PUCCH transmission that includes the UCI along with any other contents that would have been included in the PUCCH transmission 310-a. The source transmission 305-a may be dropped (e.g., not transmitted), and hence in some cases the UE 115 may be able to enter a low power mode that it otherwise would not have been able to enter or remain in the low power mode for a longer period of time due to the UCI being transmitted via the multiplexed transmission 315-a, rather than via

In some examples, such as the example illustrated in the signaling diagram 300-b of FIG. 3B, multiple UCIs associated with multiple source transmissions 305 may be multiplexed. For example, source transmissions 305-b, 305-c, and 305-d may each be associated with respective UCI messages, and each of the three respective UCI messages may be multiplexed into the destination transmission 310-b, and a resulting multiplexed transmission 315-b may be transmitted.

One or more rules may govern the quantity of UCIs that may be multiplexed (e.g., the quantity of source transmissions 305 for which associated UCIs may be multiplexed) into a single non-overlapping destination transmission 310-b. In some examples, the quantity of UCIs that may be multiplexed into a single non-overlapping destination transmission 310 may be limited to one or some other fixed quantity. In some examples, the quantity of UCIs that may be multiplexed into a single non-overlapping destination transmission 310 may be indicated to a UE 115 (e.g., as part of multiplexing information 225), such as via RRC or MAC-CE signaling. Additionally or alternatively, in some examples, the quantity of UCIs that may be multiplexed into a single non-overlapping destination transmission 310 may be limited by the resulting transmission size—e.g., any quantity or up to some limited quantity of UCIs may be multiplexed into a single non-overlapping destination transmission 310, so long as the amount of multiplexed information or the size of the resulting multiplexed transmission 315 does not exceed a threshold, which may be defined (e.g., by a standard) or indicated (e.g., as part of multiplexing information 225), such as via RRC or MAC-CE signaling. In some examples, limits with respect to a quantity of UCIs or amount of UCI information that may be multiplexed into a single non-overlapping destination transmission 310 may differ for different types of UCI (e.g., limits may be different for UCIs that include HARQ-ACK information versus UCIs that includes CSI).

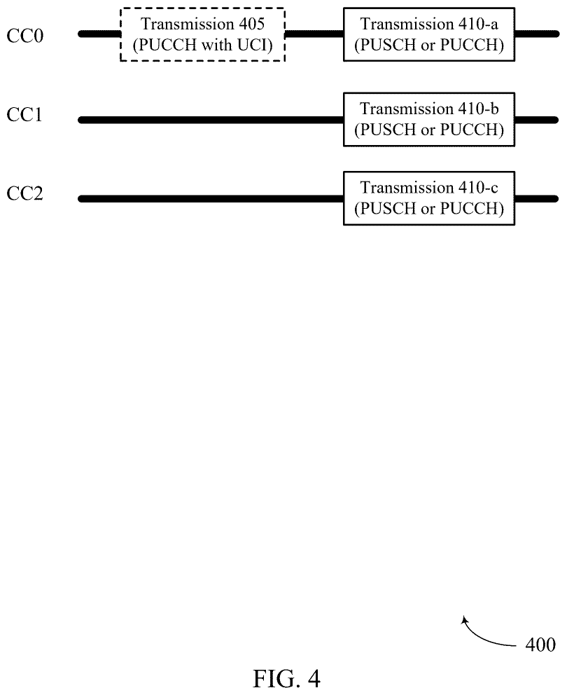

FIG. 4 shows an example of a signaling diagram 400 that supports multiplexing UCI on non-overlapping transmissions in accordance with one or more aspects of the present disclosure. The signaling diagram 400 describes multiplexing UCI on non-overlapping transmission in the example of carrier aggregation. The signaling diagram 400 may be implemented by a wireless communications system as described herein. In some examples, the multiplexing may be performed by a UE, such as a UE 115 as described herein.

When configured with multiple component carriers (e.g., when using carrier aggregation), a UE 115 may select a destination transmission 410 into which to multiplex UCI associated with a source transmission 405 in accordance with one or more rules (e.g., based on the selected destination transmission 410 satisfying one or more conditions). In some examples, the UE 115 may be limited to selecting a destination transmission 410-a that is on the same component carrier as the source transmission 405. In some examples, when destination transmissions 410 on multiple component carriers satisfy one or more other conditions, the UE 115 may select the destination transmission 410 that was scheduled by the earliest corresponding Downlink Control Information (DCI) message, regardless of which component carrier the selected destination transmission 410 is on. In some examples, the UE 115 may receive (e.g., as part of multiplexing information 225) an indication of one of the component carriers, and the UE 115 may be limited to selecting a destination transmission 410 that is on the indicated component carrier. In some examples, when destination transmissions 410 on multiple component carriers satisfy one or more other conditions, the UE 115 may select between destination transmissions 410 that are on a component carrier provided by a primary cell (PCell) or a component carrier provided by a primary cell of a secondary cell group (PSCell), and hence a destination transmission 410 that is on a component carrier provided by a secondary cell (SCell) may be ineligible for selection.

In some examples, when destination transmissions 410 on multiple component carriers satisfy one or more other conditions, the UE 115 may select the destination transmission 410 that is on the carrier associated with the lowest carrier index. In some examples, when destination transmissions 410 on multiple component carriers satisfy one or more other conditions, the UE 115 may select the destination transmission 410 that is associated with a lowest MCS or highest MCS. In some examples, when destination transmissions 410 on multiple component carriers satisfy one or more other conditions, the UE 115 may select the destination transmission 410 that is associated with a smallest transport block size or largest transport block size. In some examples, when destination transmissions 410 on multiple component carriers satisfy one or more other conditions, the UE 115 may select the destination transmission 410 that is associated with the smallest quantity of transmission layers.

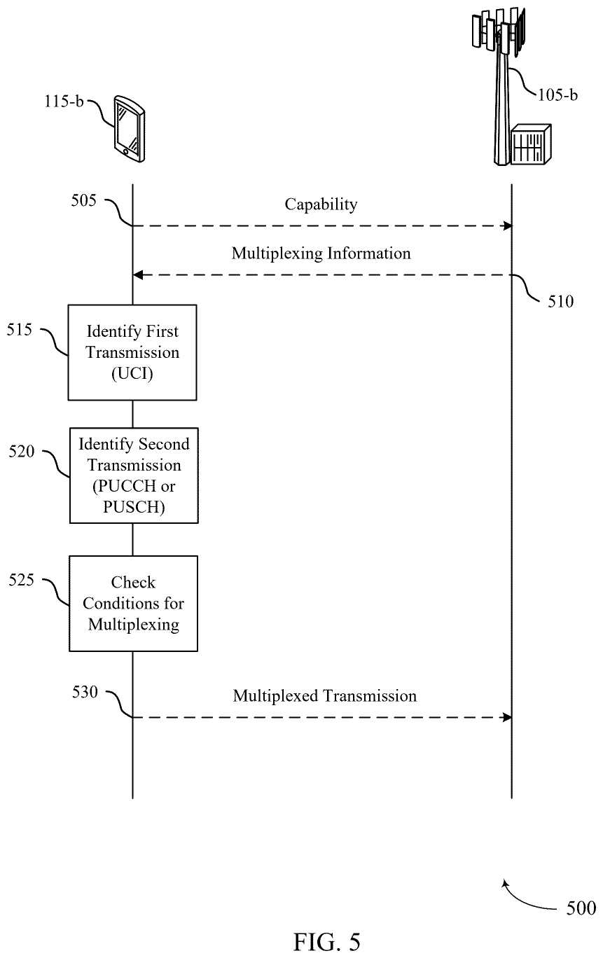

FIG. 5 shows an example of a process flow diagram 500 that supports multiplexing UCI on non-overlapping transmissions in accordance with one or more aspects of the present disclosure. The process flow diagram 500 describes the communications between a UE 115-a and a network entity 105-a, which may be examples of the UE 115 and the network entity 105 as described herein. Alternative examples of the following process flow may be implemented, where some steps are performed in a different order than described or are not performed at all. In some cases, steps may include additional features not mentioned below, or further steps may be added. While described with reference to the UE 115-b and the network entity 105-b, the steps may be performed by other devices.

At 505, the UE 115-b may transmit capability information for the UE 115-b that indicates a capability of the UE to transmit UCI associated with an uplink control channel transmission via a different uplink transmission that is non-overlapping in time with the uplink control channel transmission, a minimum time gap between the uplink control channel transmission and the different uplink transmission for which the UE supports transmitting UCI associated with the uplink control channel transmission via the different uplink transmission, a maximum time gap between the uplink control channel transmission and the different uplink transmission for which the UE supports transmitting UCI associated with the uplink control channel transmission via the different uplink transmission, or any combination thereof.

At 510, the network entity 105-b may output multiplexing information. The multiplexing information may include one or more conditions for multiplexing. For example, the multiplexing information may include an indication of a duration of a time gap threshold.

At 515, the UE 115-b may identify a UCI for transmission via a first potential uplink control channel transmission, such as a PUCCH. In some examples, the UE 115-b may identify multiple UCIs for transmission (e.g., via multiple potential uplink control channel transmissions).

At 520, the UE 115-b may identify a second uplink transmission that is non-overlapping in time with the first potential uplink control channel transmission, the second uplink transmission being an uplink shared channel transmission or a second uplink control channel transmission. For example, the second uplink transmission may be a PUSCH or a PUCCH.

At 525, the UE 115-b may determine whether the second uplink transmission satisfies one or more conditions. The one or more conditions may include receipt by the UE 115-b of signaling indicative that transmission of the UCI as part of the second uplink transmission are allowed. The one or more conditions may include a time gap between the first potential uplink control channel transmission and the second uplink transmission satisfying (e.g., being less than) a time gap threshold, as discussed, for example, above for UCI multiplexing with reference to FIG. 2. The duration for the time gap threshold may be based on a priority of the first potential uplink control channel transmission, a priority of the second uplink transmission, or both. In some examples, the UE 115-b may receive (e.g., at 510) an indication of a duration of the time gap threshold.

The one or more conditions may be based on a priority of the first potential uplink control channel transmission, a priority of the second uplink transmission, or both. In some examples, the one or more conditions may be based on a size of the UCI, a type of the UCI, or both. The one or more conditions may be based on a size of a codebook associated with the UCI, a type of the codebook associated with the UCI, or both. The one or more conditions may be based on a size of the first potential uplink control channel transmission, a size of the second uplink transmission, or both.

In some examples, the one or more conditions may include a second start time for the second uplink transmission being after a first start time for the first potential uplink control channel transmission and further include no other uplink transmission for the UE 115-b having a third start time that is between the first start time for the first potential uplink control channel transmission and the second start time for the second uplink transmission.

In some examples, if a second start time for the second uplink transmission is earlier than a first start time for the first potential uplink control channel transmission, the one or more conditions may include the second start time satisfying one or more processing time thresholds associated with the UCI, the second uplink transmission, or any combination thereof.

In some examples, the one or more conditions may include a second start time for the second uplink transmission being nearer in time to a first start time for the first potential uplink control channel transmission than a start time for any other uplink transmission for the UE 115-b for which one or more processing time thresholds associated with the UCI, the second uplink transmission, or any combination thereof are satisfied.

In some examples, the one or more conditions may include the second uplink transmission having a second end time that is earlier than a first end time for the first potential uplink control channel transmission and may further include an absence of any other uplink transmission having a start time that is within a threshold duration of the first potential uplink control channel transmission.

In some examples, the one or more conditions may include the second uplink transmission having a priority that is lower than one or more other uplink transmissions for the UE 115-b, the second uplink transmission having a greater resource allocation than the one or more other uplink transmissions for the UE 115-b, the second uplink transmission having a lower modulation and coding scheme than the one or more other uplink transmissions for the UE 115-b, or any combination thereof.

In some examples, the plurality of uplink transmissions for the UE 115-b may include the first potential uplink control channel transmission and the second uplink transmission, the plurality of uplink transmissions associated with two or more carriers, and where the one or more conditions include the second uplink transmission satisfying a selection criteria associated with the two or more carriers, as described elsewhere herein, such as with reference to FIG. 4, for example.

In some examples, transmitting the UCI as part of the second uplink transmission may be based on the first potential uplink control channel transmission being dropped.

At 530, the UE 115-a may transmit the UCI as part of the second uplink transmission based on a determination that the second uplink transmission satisfies one or more conditions.

In some examples, transmitting the UCI as part of the second uplink transmission may be in accordance with a maximum quantity of UCI messages for transmission via the second uplink transmission, a maximum amount of UCI for transmission via the second uplink transmission, or both. For example, an upper limit may exist with respect to how many source messages from which associated UCI messages may be multiplexed into a single non-overlapping destination message, or an upper limit may exist with respect to an amount of UCI (e.g., a total quantity of UCI bits) that may be multiplexed from one or more source messages into a single non-overlapping destination message, or both, and UCI that is multiplexed from one or more source messages into a single non-overlapping destination message may be in accordance with (e.g., compliant with) one or more such upper limits.

In some examples, transmitting the UCI may include transmitting, within the second uplink transmission, a medium access control-control element that includes the UCI. In some examples, based on transmitting the UCI as part of the second uplink transmission, the first potential uplink control channel transmission is not transmitted.

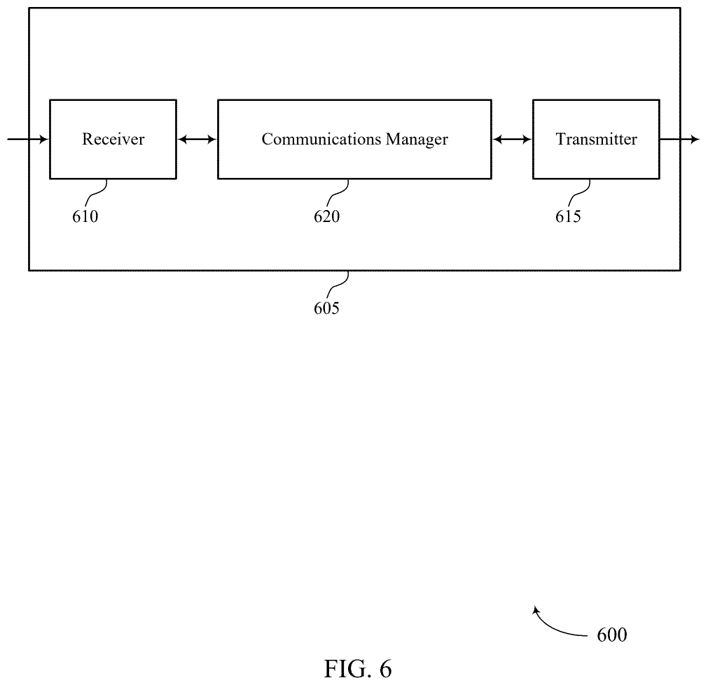

FIG. 6 shows a block diagram 600 of a device 605 that supports multiplexing UCI on non-overlapping transmissions in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to multiplexing UCI on non-overlapping transmissions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to multiplexing UCI on non-overlapping transmissions). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of multiplexing UCI on non-overlapping transmissions as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for identifying UCI for transmission via a first potential uplink control channel transmission. The communications manager 620 is capable of, configured to, or operable to support a means for identifying a second uplink transmission that is non-overlapping in time with the first potential uplink control channel transmission, the second uplink transmission including an uplink shared channel transmission or a second uplink control channel transmission. The communications manager 620 is capable of, configured to, or operable to support a means for transmitting the UCI as part of the second uplink transmission based on a determination that the second uplink transmission satisfies one or more conditions.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for multiplexing UCI on non-overlapping transmissions, which may result in various advantages, such as reduced processing, reduced power consumption, more efficient utilization of communication resources, etc.

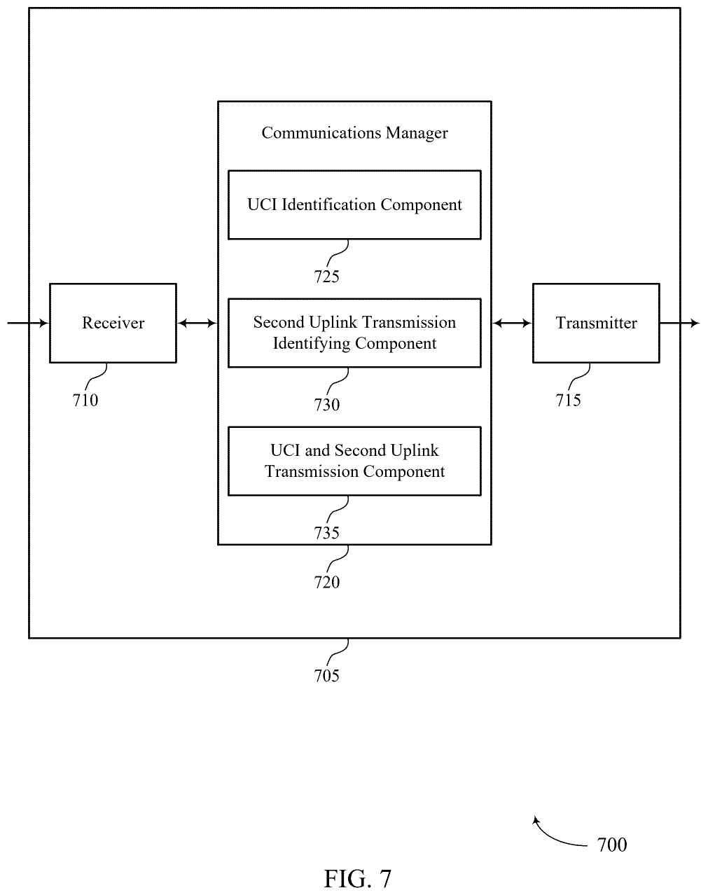

FIG. 7 shows a block diagram 700 of a device 705 that supports multiplexing UCI on non-overlapping transmissions in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to multiplexing UCI on non-overlapping transmissions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to multiplexing UCI on non-overlapping transmissions). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of multiplexing UCI on non-overlapping transmissions as described herein. For example, the communications manager 720 may include a UCI identification component 725, a second uplink transmission identifying component 730, a UCI and second uplink transmission component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The UCI identification component 725 is capable of, configured to, or operable to support a means for identifying UCI for transmission via a first potential uplink control channel transmission. The second uplink transmission identifying component 730 is capable of, configured to, or operable to support a means for identifying a second uplink transmission that is non-overlapping in time with the first potential uplink control channel transmission, the second uplink transmission including an uplink shared channel transmission or a second uplink control channel transmission. The UCI and second uplink transmission component 735 is capable of, configured to, or operable to support a means for transmitting the UCI as part of the second uplink transmission based on a determination that the second uplink transmission satisfies one or more conditions.

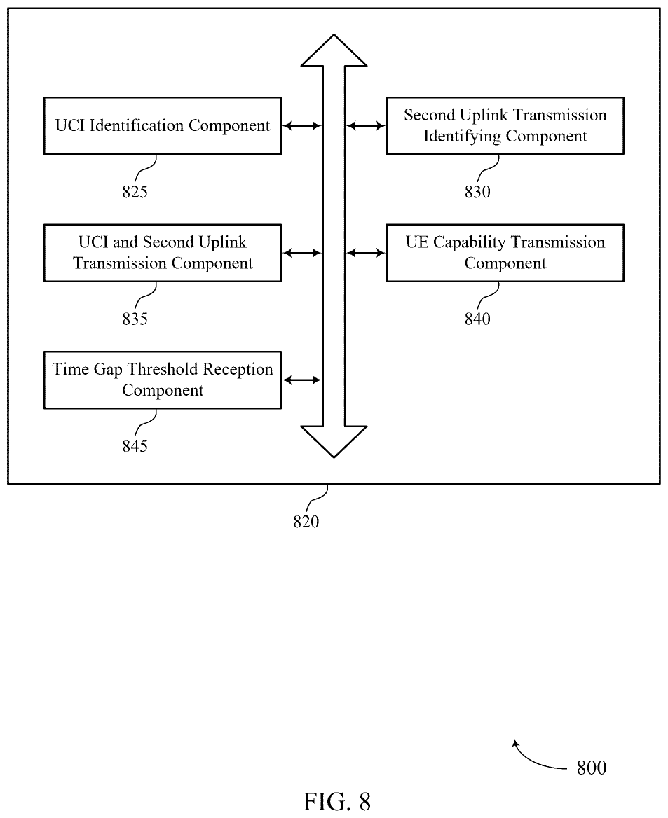

FIG. 8 shows a block diagram 800 of a communications manager 820 that supports multiplexing UCI on non-overlapping transmissions in accordance with one or more aspects of the present disclosure. The communications manager 820 may be an example of aspects of a communications manager 620, a communications manager 720, or both, as described herein. The communications manager 820, or various components thereof, may be an example of means for performing various aspects of multiplexing UCI on non-overlapping transmissions as described herein. For example, the communications manager 820 may include a UCI identification component 825, a second uplink transmission identifying component 830, a UCI and second uplink transmission component 835, a UE capability transmission component 840, a time gap threshold reception component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The UCI identification component 825 is capable of, configured to, or operable to support a means for identifying UCI for transmission via a first potential uplink control channel transmission. The second uplink transmission identifying component 830 is capable of, configured to, or operable to support a means for identifying a second uplink transmission that is non-overlapping in time with the first potential uplink control channel transmission, the second uplink transmission including an uplink shared channel transmission or a second uplink control channel transmission. The UCI and second uplink transmission component 835 is capable of, configured to, or operable to support a means for transmitting the UCI as part of the second uplink transmission based on a determination that the second uplink transmission satisfies one or more conditions.

In some examples, the one or more conditions include receipt by the UE of signaling indicative that transmission of the UCI as part of the second uplink transmission are allowed.

In some examples, the one or more conditions include a time gap between the first potential uplink control channel transmission and the second uplink transmission satisfying a time gap threshold. In some examples, the time gap threshold reception component 845 is capable of, configured to, or operable to support a means for receiving an indication of a duration of the time gap threshold. In some examples, a duration of the time gap threshold is based on a priority of the first potential uplink control channel transmission, a priority of the second uplink transmission, or both.

In some examples, the one or more conditions are based on a priority of the first potential uplink control channel transmission, a priority of the second uplink transmission, or both. In some examples, the one or more conditions are based on a size of the UCI, a type of the UCI, or both. In some examples, the one or more conditions are based on a size of a codebook associated with the UCI, a type of the codebook associated with the UCI, or both. In some examples, the one or more conditions are based on a size of the first potential uplink control channel transmission, a size of the second uplink transmission, or both.

In some examples, the one or more conditions include a second start time for the second uplink transmission being after a first start time for the first potential uplink control channel transmission and further include no other uplink transmission for the UE having a third start time that is between the first start time for the first potential uplink control channel transmission and the second start time for the second uplink transmission.

In some examples, when a second start time for the second uplink transmission is earlier than a first start time for the first potential uplink control channel transmission, the one or more conditions include the second start time satisfying one or more processing time thresholds associated with the UCI, the second uplink transmission, or any combination thereof.

In some examples, the one or more conditions include a second start time for the second uplink transmission being nearer in time to a first start time for the first potential uplink control channel transmission than a start time for any other uplink transmission for the UE for which one or more processing time thresholds associated with the UCI, the second uplink transmission, or any combination thereof are satisfied.

In some examples, the one or more conditions include the second uplink transmission having a second end time that is earlier than a first end time for the first potential uplink control channel transmission and further includes an absence of any other uplink transmission having a start time that is within a threshold duration of the first potential uplink control channel transmission.

In some examples, the one or more conditions include the second uplink transmission having a priority that is lower than one or more other uplink transmissions for the UE, the second uplink transmission having a greater resource allocation than the one or more other uplink transmissions for the UE, the second uplink transmission having a lower modulation and coding scheme than the one or more other uplink transmissions for the UE, or any combination thereof.

In some examples, a set of multiple uplink transmissions for the UE includes the first potential uplink control channel transmission and the second uplink transmission, the set of multiple uplink transmissions associated with two or more carriers. In some examples, the one or more conditions include the second uplink transmission satisfying a selection criteria associated with the two or more carriers.

In some examples, transmitting the UCI as part of the second uplink transmission is further based on the first potential uplink control channel transmission being dropped.

In some examples, the UE capability transmission component 840 is capable of, configured to, or operable to support a means for transmitting capability information for the UE that indicates. a capability of the UE to transmit UCI associated with an uplink control channel transmission via a different uplink transmission that is non-overlapping in time with the uplink control channel transmission, a minimum time gap between the uplink control channel transmission and the different uplink transmission for which the UE supports transmitting UCI associated with the uplink control channel transmission via the different uplink transmission, a maximum time gap between the uplink control channel transmission and the different uplink transmission for which the UE supports transmitting UCI associated with the uplink control channel transmission via the different uplink transmission, or any combination thereof.

In some examples, transmitting the UCI as part of the second uplink transmission is in accordance with a maximum quantity of UCI messages for transmission via the second uplink transmission, a maximum amount of UCI for transmission via the second uplink transmission, or both.

In some examples, to support transmitting the UCI as part of the second uplink transmission, the UCI and second uplink transmission component 835 is capable of, configured to, or operable to support a means for transmitting, within the second uplink transmission, a medium access control-control element that includes the UCI.

In some examples, based on transmitting the UCI as part of the second uplink transmission, the first potential uplink control channel transmission is not transmitted.

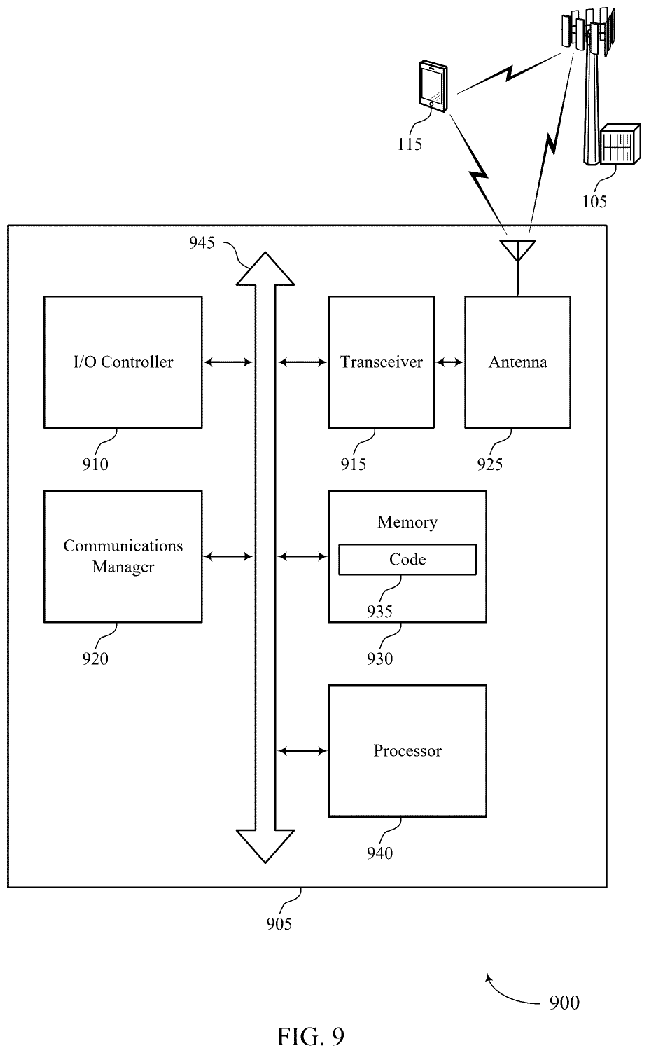

FIG. 9 shows a diagram of a system 900 including a device 905 that supports multiplexing UCI on non-overlapping transmissions in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting multiplexing UCI on non-overlapping transmissions). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for identifying UCI for transmission via a first potential uplink control channel transmission. The communications manager 920 is capable of, configured to, or operable to support a means for identifying a second uplink transmission that is non-overlapping in time with the first potential uplink control channel transmission, the second uplink transmission including an uplink shared channel transmission or a second uplink control channel transmission. The communications manager 920 is capable of, configured to, or operable to support a means for transmitting the UCI as part of the second uplink transmission based on a determination that the second uplink transmission satisfies one or more conditions.

By including or configuring the communications manager 920 in accordance with examples as described herein, the device 905 may support techniques for multiplexing UCI on non-overlapping transmissions, which may result in various advantages, such as improved communication reliability, reduced latency, improved user experience related to reduced processing, reduced power consumption, more efficient utilization of communication resources, improved coordination between devices, longer battery life, improved utilization of processing capability, etc.

In some examples, the communications manager 920 may be configured to perform various operations (e.g., receiving, monitoring, transmitting) using or otherwise in cooperation with the transceiver 915, the one or more antennas 925, or any combination thereof. For example, the communications manager 920 may be configured to receive or transmit messages or other signaling as described herein via the transceiver 915. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of multiplexing UCI on non-overlapping transmissions as described herein, or the at least one processor 940 and the at least one memory 930 may be otherwise configured to, individually or collectively, perform or support such operations.

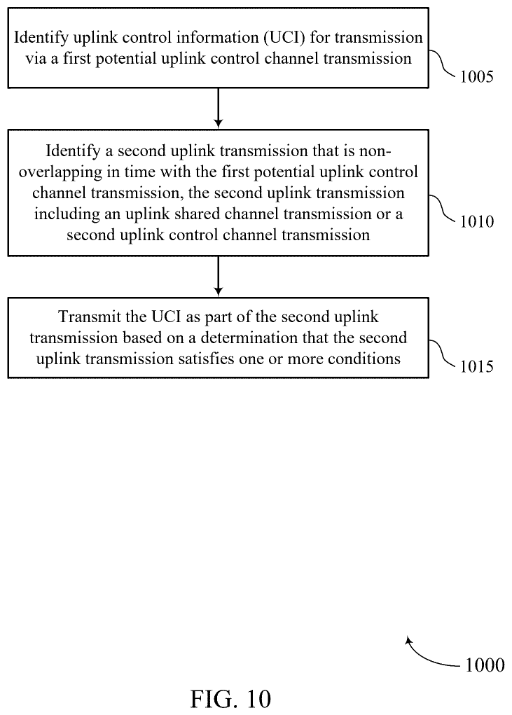

FIG. 10 shows a flowchart illustrating a method 1000 that supports multiplexing UCI on non-overlapping transmissions in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include identifying UCI for transmission via a first potential uplink control channel transmission. The operations of 1005 may be performed in accordance with examples as disclosed herein. In some examples, aspects of the operations of 1005 may be performed by a UCI identification component 825 as described with reference to FIG. 8. Additionally or alternatively, means for performing 1005 may, but not necessarily, include, for example, antenna 925, transceiver 915, communications manager 920, memory 930 (including code 935), processor 940 and/or bus 945.

At 1010, the method may include identifying a second uplink transmission that is non-overlapping in time with the first potential uplink control channel transmission, the second uplink transmission including an uplink shared channel transmission or a second uplink control channel transmission. The operations of 1010 may be performed in accordance with examples as disclosed herein. In some examples, aspects of the operations of 1010 may be performed by a second uplink transmission identifying component 830 as described with reference to FIG. 8. Additionally or alternatively, means for performing 1010 may, but not necessarily, include, for example, antenna 925, transceiver 915, communications manager 920, memory 930 (including code 935), processor 940 and/or bus 945.

At 1015, the method may include transmitting the UCI as part of the second uplink transmission based on a determination that the second uplink transmission satisfies one or more conditions. The operations of 1015 may be performed in accordance with examples as disclosed herein. In some examples, aspects of the operations of 1015 may be performed by a UCI and second uplink transmission component 835 as described with reference to FIG. 8. Additionally or alternatively, means for performing 1015 may, but not necessarily, include, for example, antenna 925, transceiver 915, communications manager 920, memory 930 (including code 935), processor 940 and/or bus 945.

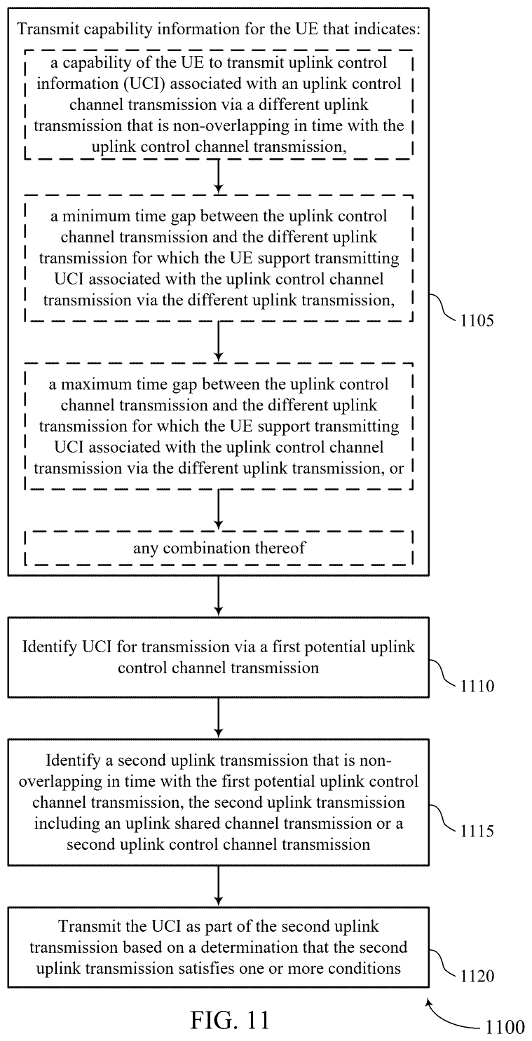

FIG. 11 shows a flowchart illustrating a method 1100 that supports multiplexing UCI on non-overlapping transmissions in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include transmitting capability information. In some examples, the capability information may indicate a capability of the UE to transmit UCI associated with an uplink control channel transmission via a different uplink transmission that is non-overlapping in time with the uplink control channel transmission, a minimum time gap between the uplink control channel transmission and the different uplink transmission for which the UE supports transmitting UCI associated with the uplink control channel transmission via the different uplink transmission, a maximum time gap between the uplink control channel transmission and the different uplink transmission for which the UE supports transmitting UCI associated with the uplink control channel transmission via the different uplink transmission, or any combination thereof. The operations of 1105 may be performed in accordance with examples as disclosed herein. In some examples, aspects of the operations of 1105 may be performed by a UE capability transmission component 840 as described with reference to FIG. 8. Additionally or alternatively, means for performing 1105 may, but not necessarily, include, for example, antenna 925, transceiver 915, communications manager 920, memory 930 (including code 935), processor 940 and/or bus 945.

At 1110, the method may include identifying UCI for transmission via a first potential uplink control channel transmission. The operations of 1110 may be performed in accordance with examples as disclosed herein. In some examples, aspects of the operations of 1110 may be performed by a UCI identification component 825 as described with reference to FIG. 8. Additionally or alternatively, means for performing 1110 may, but not necessarily, include, for example, antenna 925, transceiver 915, communications manager 920, memory 930 (including code 935), processor 940 and/or bus 945.

At 1115, the method may include identifying a second uplink transmission that is non-overlapping in time with the first potential uplink control channel transmission, the second uplink transmission including an uplink shared channel transmission or a second uplink control channel transmission. The operations of 1115 may be performed in accordance with examples as disclosed herein. In some examples, aspects of the operations of 1115 may be performed by a second uplink transmission identifying component 830 as described with reference to FIG. 8. Additionally or alternatively, means for performing 1115 may, but not necessarily, include, for example, antenna 925, transceiver 915, communications manager 920, memory 930 (including code 935), processor 940 and/or bus 945.

At 1120, the method may include transmitting the UCI as part of the second uplink transmission based on a determination that the second uplink transmission satisfies one or more conditions. The operations of 1120 may be performed in accordance with examples as disclosed herein. In some examples, aspects of the operations of 1120 may be performed by a UCI and second uplink transmission component 835 as described with reference to FIG. 8. Additionally or alternatively, means for performing 1120 may, but not necessarily, include, for example, antenna 925, transceiver 915, communications manager 920, memory 930 (including code 935), processor 940 and/or bus 945.

The following provides an overview of aspects of the present disclosure:

Aspect 1: A method for wireless communications at a UE, comprising: identifying UCI for transmission via a first potential uplink control channel transmission; identifying a second uplink transmission that is non-overlapping in time with the first potential uplink control channel transmission, the second uplink transmission comprising an uplink shared channel transmission or a second uplink control channel transmission; and transmitting, via the transceiver, the UCI as part of the second uplink transmission based at least in part on a determination that the second uplink transmission satisfies one or more conditions.

Aspect 2: The method of aspect 1, wherein the one or more conditions comprise receipt by the UE of signaling indicative that transmission of the UCI as part of the second uplink transmission is allowed.

Aspect 3: The method of any of aspects 1 through 2, wherein the one or more conditions comprise a time gap between the first potential uplink control channel transmission and the second uplink transmission satisfying a time gap threshold.

Aspect 4: The method of aspect 3, further comprising: receiving, via the transceiver, an indication of a duration of the time gap threshold.

Aspect 5: The method of aspect 3, wherein a duration of the time gap threshold is based at least in part on a priority of the first potential uplink control channel transmission, a priority of the second uplink transmission, or both.

Aspect 6: The method of any of aspects 1 through 5, wherein the one or more conditions are based at least in part on a priority of the first potential uplink control channel transmission, a priority of the second uplink transmission, or both.

Aspect 7: The method of any of aspects 1 through 6, wherein the one or more conditions are based at least in part on a size of the UCI, a type of the UCI, or both.

Aspect 8: The method of any of aspects 1 through 7, wherein the one or more conditions are based at least in part on a size of a codebook associated with the UCI, a type of the codebook associated with the UCI, or both.

Aspect 9: The method of any of aspects 1 through 8, wherein the one or more conditions are based at least in part on a size of the first potential uplink control channel transmission, a size of the second uplink transmission, or both.

Aspect 10: The method of any of aspects 1 through 9, wherein the one or more conditions comprise a second start time for the second uplink transmission being after a first start time for the first potential uplink control channel transmission and further comprise no other uplink transmission for the UE having a start time that is between the first start time for the first potential uplink control channel transmission and the second start time for the second uplink transmission.

Aspect 11: The method of any of aspects 1 through 10, wherein, when a second start time for the second uplink transmission is earlier than a first start time for the first potential uplink control channel transmission, the one or more conditions comprise the second start time satisfying one or more processing time thresholds associated with the UCI, the second uplink transmission, or any combination thereof.

Aspect 12: The method of any of aspects 1 through 11, wherein the one or more conditions comprise a second start time for the second uplink transmission being nearer in time to a first start time for the first potential uplink control channel transmission than any other uplink transmission for the UE for which one or more processing time thresholds associated with the UCI, the second uplink transmission, or any combination thereof are satisfied.

Aspect 13: The method of any of aspects 1 through 12, wherein the one or more conditions comprise the second uplink transmission having a second end time that is earlier than a first end time for the first potential uplink control channel transmission and further comprise an absence of any other uplink transmission having a start time that is within a threshold duration of the first potential uplink control channel transmission.

Aspect 14: The method of any of aspects 1 through 13, wherein the one or more conditions comprise the second uplink transmission having a priority that is lower than one or more other uplink transmissions for the UE, the second uplink transmission having a greater resource allocation than the one or more other uplink transmissions for the UE, the second uplink transmission having a lower modulation and coding scheme than the one or more other uplink transmissions for the UE, or any combination thereof.

Aspect 15: The method of any of aspects 1 through 14, wherein: a plurality of uplink transmissions for the UE comprises the first potential uplink control channel transmission and the second uplink transmission, the plurality of uplink transmissions associated with two or more carriers, and the one or more conditions comprise the second uplink transmission satisfying a selection criteria associated with the two or more carriers.

Aspect 16: The method of any of aspects 1 through 15, wherein: transmitting the UCI as part of the second uplink transmission is further based at least in part on the first potential uplink control channel transmission being dropped.

Aspect 17: The method of any of aspects 1 through 16, further comprising: transmitting, via the transceiver, capability information for the UE that indicates: a capability of the UE to transmit UCI associated with an uplink control channel transmission via a different uplink transmission that is non-overlapping in time with the uplink control channel transmission, a minimum time gap between the uplink control channel transmission and the different uplink transmission for which the UE supports transmitting UCI associated with the uplink control channel transmission via the different uplink transmission, a maximum time gap between the uplink control channel transmission and the different uplink transmission for which the UE supports transmitting UCI associated with the uplink control channel transmission via the different uplink transmission, or any combination thereof.

Aspect 18: The method of any of aspects 1 through 17, wherein transmitting the UCI as part of the second uplink transmission is in accordance with a maximum quantity of UCI messages for transmission via the second uplink transmission, a maximum amount of UCI for transmission via the second uplink transmission, or both.

Aspect 19: The method of any of aspects 1 through 18, wherein transmitting the UCI as part of the second uplink transmission comprises: transmitting, within the second uplink transmission, a medium access control-control element that comprises the UCI.

Aspect 20: The method of any of aspects 1 through 19, wherein, based at least in part on transmitting the UCI as part of the second uplink transmission, the first potential uplink control channel transmission is not transmitted.

Aspect 21: A UE for wireless communications, comprising one or more memories storing processor-executable code, a transceiver, and one or more processors coupled with the one or more memories and the transceiver, the one or more processors individually or collectively operable to execute the code to cause the UE to perform a method of any of aspects 1 through 20.

Aspect 22: A UE for wireless communications, comprising at least one means for performing a method of any of aspects 1 through 20.

Aspect 23: A non-transitory computer-readable medium storing code for wireless communications, the code comprising instructions executable by one or more processors to perform a method of any of aspects 1 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code;
a transceiver; and
one or more processors coupled with the one or more memories and the transceiver, the one or more processors individually or collectively operable to execute the code to cause the UE to:
identify uplink control information (UCI) for transmission via a first potential uplink control channel transmission;
identify a second uplink transmission that is non-overlapping in time with the first potential uplink control channel transmission, the second uplink transmission comprising an uplink shared channel transmission or a second uplink control channel transmission; and
transmit, via the transceiver, the UCI as part of the second uplink transmission based at least in part on a determination that the second uplink transmission satisfies one or more conditions.

2. The UE of claim 1, wherein the one or more conditions comprise receipt by the UE of signaling indicative that transmission of the UCI as part of the second uplink transmission is allowed.

3. The UE of claim 1, wherein the one or more conditions comprise a time gap between the first potential uplink control channel transmission and the second uplink transmission satisfying a time gap threshold.

4. The UE of claim 3, wherein the one or more processors are individually or collectively further operable to execute the code to cause the UE to:
receive, via the transceiver, an indication of a duration of the time gap threshold.

5. The UE of claim 3, wherein a duration of the time gap threshold is based at least in part on a priority of the first potential uplink control channel transmission, a priority of the second uplink transmission, or both.

6. The UE of claim 1, wherein the one or more conditions are based at least in part on a priority of the first potential uplink control channel transmission, a priority of the second uplink transmission, or both.

7. The UE of claim 1, wherein the one or more conditions are based at least in part on a size of the UCI, a type of the UCI, or both.

8. The UE of claim 1, wherein the one or more conditions are based at least in part on a size of a codebook associated with the UCI, a type of the codebook associated with the UCI, or both.

9. The UE of claim 1, wherein the one or more conditions are based at least in part on a size of the first potential uplink control channel transmission, a size of the second uplink transmission, or both.

10. The UE of claim 1, wherein the one or more conditions comprise a second start time for the second uplink transmission being after a first start time for the first potential uplink control channel transmission and further comprise no other uplink transmission for the UE having a start time that is between the first start time for the first potential uplink control channel transmission and the second start time for the second uplink transmission.

11. The UE of claim 1, wherein, when a second start time for the second uplink transmission is earlier than a first start time for the first potential uplink control channel transmission, the one or more conditions comprise the second start time satisfying one or more processing time thresholds associated with the UCI, the second uplink transmission, or any combination thereof.

12. The UE of claim 1, wherein the one or more conditions comprise a second start time for the second uplink transmission being nearer in time to a first start time for the first potential uplink control channel transmission than any other uplink transmission for the UE for which one or more processing time thresholds associated with the UCI, the second uplink transmission, or any combination thereof are satisfied.

13. The UE of claim 1, wherein the one or more conditions comprise the second uplink transmission having a second end time that is earlier than a first end time for the first potential uplink control channel transmission and further comprise an absence of any other uplink transmission having a start time that is within a threshold duration of the first potential uplink control channel transmission.

14. The UE of claim 1, wherein the one or more conditions comprise the second uplink transmission having a priority that is lower than one or more other uplink transmissions for the UE, the second uplink transmission having a greater resource allocation than the one or more other uplink transmissions for the UE, the second uplink transmission having a lower modulation and coding scheme than the one or more other uplink transmissions for the UE, or any combination thereof.

15. The UE of claim 1, wherein:
a plurality of uplink transmissions for the UE comprises the first potential uplink control channel transmission and the second uplink transmission, the plurality of uplink transmissions associated with two or more carriers, and
the one or more conditions comprise the second uplink transmission satisfying a selection criteria associated with the two or more carriers.

16. The UE of claim 1, wherein:
transmitting the UCI as part of the second uplink transmission is further based at least in part on the first potential uplink control channel transmission being dropped.

17. The UE of claim 1, wherein the one or more processors are individually or collectively further operable to execute the code to cause the UE to:
transmit, via the transceiver, capability information for the UE that indicates:
a capability of the UE to transmit UCI associated with an uplink control channel transmission via a different uplink transmission that is non-overlapping in time with the uplink control channel transmission,
a minimum time gap between the uplink control channel transmission and the different uplink transmission for which the UE supports transmitting UCI associated with the uplink control channel transmission via the different uplink transmission,
a maximum time gap between the uplink control channel transmission and the different uplink transmission for which the UE supports transmitting UCI associated with the uplink control channel transmission via the different uplink transmission, or
any combination thereof.

18. The UE of claim 1, wherein transmitting the UCI as part of the second uplink transmission is in accordance with a maximum quantity of UCI messages for transmission via the second uplink transmission, a maximum amount of UCI for transmission via the second uplink transmission, or both.

19. A method for wireless communications at a user equipment (UE), comprising:
identifying uplink control information (UCI) for transmission via a first potential uplink control channel transmission;
identifying a second uplink transmission that is non-overlapping in time with the first potential uplink control channel transmission, the second uplink transmission comprising an uplink shared channel transmission or a second uplink control channel transmission; and
transmitting the UCI as part of the second uplink transmission based at least in part on a determination that the second uplink transmission satisfies one or more conditions.

20. A non-transitory computer-readable medium storing code for wireless communications, the code comprising instructions executable by one or more processors to:
identify uplink control information (UCI) for transmission via a first potential uplink control channel transmission;
identify a second uplink transmission that is non-overlapping in time with the first potential uplink control channel transmission, the second uplink transmission comprising an uplink shared channel transmission or a second uplink control channel transmission; and
transmit the UCI as part of the second uplink transmission based at least in part on a determination that the second uplink transmission satisfies one or more conditions.
